(19) United States
(12) Patent Application Publication
(10) Pub. No.: US 2007/0189371 A1
(43) Pub. Date: Aug. 16, 2007

(54) QUADRATURE MODULATION TRANSCEIVER AND PARAMETER ESTIMATING METHOD FOR IQ IMBALANCE CALIBRATION

(76) Inventor: Shin-Chieh Yen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/672,970

(22) Filed: Feb. 9, 2007

(30) Foreign Application Priority Data
Feb. 10, 2006 (TW) 095104599

(51) Int. Cl. H04L 5/16

(52) U.S. Cl. 375/219; 375/221

(57) ABSTRACT

A quadrature modulation transceiver is capable of receiving an in-phase component and a quadrature-phase component corresponding to an input signal, and generating a transmitting signal by up-converting the in-phase component and the quadrature-phase component according to an in-phase transmitting carrier and a quadrature-phase transmitting carrier respectively. The quadrature modulation transceiver then adjusts the transmitting signal using a loopback parameter to generate a loopback signal. Next, the quadrature modulation transceiver down-converts the loopback signal to generate a receiving signal according to an in-phase receiving carrier and a quadrature-phase receiving carrier. Finally, the quadrature modulation transceiver computes calibration parameters of IQ imbalance for the transceiver calibration.

### BACKGROUND OF THE INVENTION

1. Field of the Invention

The present invention relates to a communication apparatus and calibration method thereof, and more particularly, to a quadrature modulation transceiver and parameter estimating method for calibrating IQ imbalance.

2. Description of the Prior Art

Please refer to FIG. 1. FIG. 1 is a diagram of a prior art quadrature amplitude modulation (QAM) transceiver 100. As shown in FIG. 1, the transmitting end of a prior art QAM transceiver 100 utilizes mixers 110 and 120 to up-convert an in-phase component Iₜ and a quadrature-phase component Qₜ of a base-band signal or an intermediate-frequency (IF) signal, where an in-phase transmitting carrier S_{It} and a quadrature-phase transmitting carrier S_{Qt} are respectively mixed with the in-phase component Iₜ and the quadrature-phase component Qₜ to generate a transmitting signal Sₜ for transmission by an antenna 150. At the receiving end of a prior art QAM transceiver 100, a receiving signal Sᵣ is received by an antenna 160 and fed into mixers 130 and 140. Mixers 130 and 140 respectively utilize an in-phase receiving carrier S_{Ir} and a quadrature-phase receiving carrier S_{Qr} to down-convert the receiving signal Sᵣ and generate an in-phase component Iᵣ and a quadrature-phase component Qᵣ. Ideally, the in-phase transmitting carrier S_{It} and the quadrature-phase transmitting carrier S_{Qt} are mutually orthogonal and their amplitudes are identical. Similarly the in-phase receiving carrier S_{Ir} and the quadrature-phase receiving carrier S_{Qr} are ideally mutually orthogonal with their amplitudes being identical. This will result in a balanced IQ in the QAM transceiver 100. However, under practical conditions, IQ imbalance is usually inherent in the QAM transceiver—the key reason of IQ imbalance being that the lengths of traces designed on the circuit layout are not ideally matched. Additionally, IQ imbalance is largely affected by increasingly higher carrier frequencies even though the lengths of traces are just slightly different.

There are four main error parameters commonly used in IQ imbalance modeling. These parameters are: the phase error of the transmitting carrier, the amplitude error of the transmitting carrier, the phase error of the receiving carrier, and the amplitude error of the receiving carrier. Many prior art methods for calibrating IQ imbalance are proposed, most of which additionally utilizing a sequential searching method. Through sequential searching, each error parameter is adjusted one at a time, with subsequent adjustments to other parameters following to fine tune the IQ until calibration is systematically completed. The error parameters corresponding to the transmitting end are usually adjusted first, and then the error parameters corresponding to the receiving end are adjusted. However, a cost function is still necessary for measuring the current level of IQ imbalance to act as a reference in adjusting the error parameters. The sequential searching method is finished when the value of the cost function reaches a local minimum. These methods for calibrating IQ imbalance using simple concepts can be implemented easily, however many errors can still result.

Firstly, the transmitting end and the receiving end are not calibrated in the same procedure. Alternatively, the error parameters corresponding to the transmitting end are first calibrated followed by the error parameters corresponding to the receiving end. This method of calibration leads to error propagation if the calibration is incorrect. More specifically, a potential calibrating error at the transmitting end would be propagated to the receiving end, further increasing the resulting calibration error at the receiving end. Secondly, according to these conventional methods, extra analog circuits are necessary to perform follow-up signal processing and then extra error items are resulted while the calibration procedure is performed. This will greatly influence and affect the accuracy of the calibration procedure. Finally, the use of a cost function and searching algorithm does not depend only on minimized error parameters. In performing the calibration procedure for IQ imbalance, the convergence and convergence speed of the cost function are considered largely, and the convergence and convergence speed of the cost function are influenced by the cost function itself, the searching algorithm, and the initial state. The choice of a cost function shall not be overly complicated such that the acceptable convergence speed will not be too slow. Since the error parameters are mutually dependent, an optimum searching method should be a two-dimension searching method. However, the complexity involved with a two-dimension searching method is much higher and difficult to arrive at a convergence. This is the main reason why a sequential searching method is typically adopted according to the prior art, although a lower degree of accuracy is attained. All of these in the prior art are difficult and deficient.

### SUMMARY OF THE INVENTION

It is therefore one of the objectives of the claimed invention to provide a loopback component to generate a loopback signal. The loopback signal possesses a different amplitude or different phase in order to calibrate IQ imbalance in the quadrature modulation transceiver (for example, the QAM transceiver). In this way, a parameter estimating method is provided to solve the above-mentioned problems.

According to the present invention, a quadrature modulation transceiver is disclosed. The quadrature modulation transceiver comprises a transmitter, a loopback component, a receiver, and a calibration unit. The transmitter is utilized to receive an in-phase component and a quadrature-phase component corresponding to an input signal, and generating a transmitting signal by up-converting the in-phase component and the quadrature-phase component according to an in-phase transmitting carrier and a quadrature-phase transmitting carrier respectively. The loopback component is coupled to the transmitter and is utilized to provide a loopback parameter to adjust the transmitting signal such that a loopback signal is generated. The loopback component also comprises a plurality of sets of loopback parameters, with the loopback parameter being one set of the plurality of sets of loopback parameters. The receiver is coupled to the loopback component and is utilized to down-convert the loopback signal to generate an in-phase component and a quadrature-phase component corresponding to a receiving signal according to an in-phase receiving carrier and a quadrature-phase receiving carrier respectively. The calibration unit is coupled to the transmitter and the receiver and is utilized to generate the input signal, to receive the receiving signal, and to compute calibration parameters for IQ imbalance of the quadrature modulation transceiver.

According to the present invention, a method for estimating calibration parameters for IQ imbalance applicable to a quadrature modulation transceiver is disclosed. First, an in-phase component and a quadrature-phase component is received from an input signal and up-converted to generate a transmitting signal according to an in-phase transmitting carrier and a quadrature-phase transmitting carrier respectively. Second, the method utilizes a loopback parameter to adjust the transmitting signal such that a loopback signal is generated. Third, the method down-converts the loopback signal to generate an in-phase component and a quadrature-phase component of a receiving signal according to an in-phase receiving carrier and a quadrature-phase receiving carrier respectively. Finally, the method computes the calibration parameters of IQ imbalance of the quadrature modulation transceiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art quadrature amplitude modulation (QAM) transceiver.

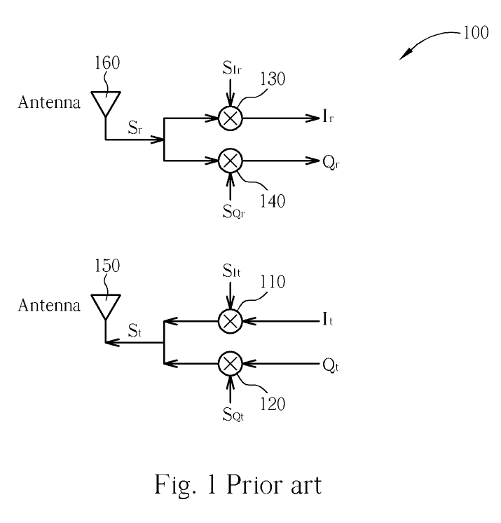

FIG. 2 is a diagram of an embodiment of a QAM transceiver according to the present invention.

FIG. 3 is a diagram illustrating the relation between the amplitude and frequency in an ideally mixed signal.

FIG. 4 is a diagram illustrating the relation between the amplitude and frequency in a mixed signal corresponding to a quadrature-phase carrier with an extra phase shift.

FIG. 5 is a diagram of a loopback component shown in FIG. 2.

FIG. 6 is a diagram of a path selector shown in FIG. 2.

### DETAILED DESCRIPTION

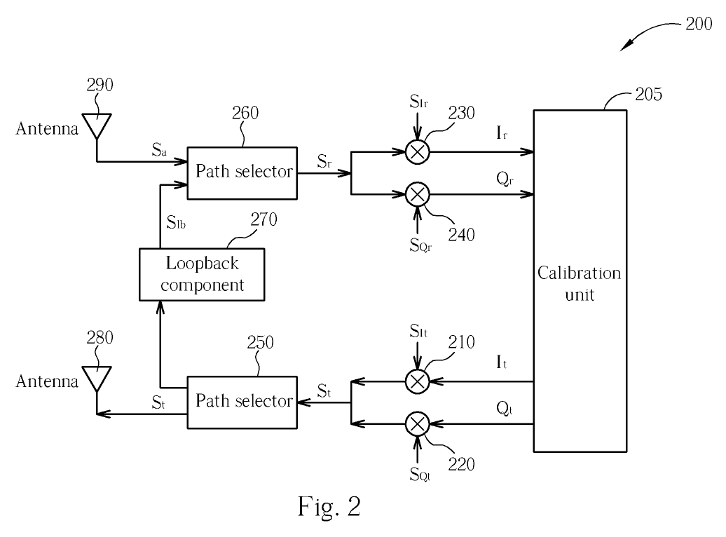

Please refer to FIG. 2. FIG. 2 is a diagram of an embodiment of the QAM transceiver 200 according to the present invention. As shown in FIG. 2, the QAM transceiver 200 comprises a calibration unit 205, a plurality of mixers 210, 220, 230, 240, a plurality of path selectors 250, 260, a loopback component 270, and a plurality of antennas 280, 290. When the QAM transceiver 200 is operating, the mixer 210 receives an in-phase component Iₜ of a received signal and up-converts the in-phase component Iₜ with an in-phase transmitting carrier S_{It}. Another mixer 220 receives the quadrature-phase component Qₜ of the received signal and up-converts the quadrature-phase component Qₜ with a quadrature-phase transmitting carrier S_{Qt}. The output signals from mixers 210 and 220 are then combined to generate a transmitting signal Sₜ. Under normal transceiver conditions, the path selector 250 selects and transmits the transmitting signal Sₜ to the antenna 280 for broadcast.

As to the receiving end, an antenna receiving signal Sₐ is received by the antenna 290, and then transmitted to the path selector 260. The path selector 260 then selects and outputs the receiving signal Sᵣ into mixers 230 and 240 respectively. The mixer 230 down-converts the receiving signal Sᵣ with an in-phase receiving carrier S_{Ir} to generate an in-phase component Iᵣ corresponding to an output signal, while the mixer 240 down-converts the receiving signal Sᵣ with a quadrature-phase receiving carrier S_{Qr} to generate a quadrature-phase component Qᵣ corresponding to the output signal. Please note that under normal transceiver conditions, the receiving signal Sᵣ is identical to the antenna receiving signal Sₐ, so that the path selector 260 simply bypasses the antenna receiving signal Sₐ. Assuming an ideal operating condition, the phase difference between an in-phase transmitting carrier S_{It} and a quadrature-phase transmitting carrier S_{Qt} is 90°, with their amplitudes are identical. The in-phase component Iₜ and the quadrature-phase component Qₜ are both sinusoidal signals with frequency f₂, which are represented as follows:

Iₜ=a×cos(2πf₂t) Eq. (1)

Qₜ=a×sin(2πf₂t) Eq. (2)

In the above equations, ‘a’ represents the amplitude of the respective signal, while ‘t’ represents time.

If the in-phase carrier S_{Ir} and the quadrature-phase carrier S_{Qr} are sinusoidal signals with a high frequency f₁ and represented as cos(2πf₁t) and −sin(2πf₁t) respectively, the in-phase component Iᵣ and the quadrature-phase component Qᵣ are mixed and combined to generate a transmitting signal Sₜ through the in-phase carrier S_{Ir} and the quadrature-phase carrier S_{Qr} respectively. The transmitting signal Sₜ can be represented with a summation of the following equations:

$$\begin{matrix}a \times cos ( 2 π {f}_{1} t ) cos ( 2 π {f}_{2} t ) = \frac{a}{2} cos ( ( 2 π {f}_{1} - 2 π {f}_{2} ) t ) + \frac{a}{2} cos ( ( 2 π {f}_{1} + 2 π {f}_{2} ) t ) & Eq . ( 3 ) \\ - a \times sin ( 2 π {f}_{1} t ) sin ( 2 π {f}_{2} t ) = \frac{- a}{2} cos ( ( 2 π {f}_{1} - 2 π {f}_{2} ) t ) + \frac{a}{2} cos ( ( 2 π {f}_{1} + 2 π {f}_{2} ) t ) & Eq . ( 4 )\end{matrix}$$

As shown through Equation (3) and Equation (4), the lower sideband (f₁−f₂) signal would be completely eliminated and only the upper sideband (f₁+f₂) signal remains. Therefore a single sideband signal results. In the same way, the upper sideband (f₁+f₂) signal could be eliminated and the lower sideband (f₁−f₂) signal remains such that a single sideband signal is generated through inverting one or three of the in-phase carrier S_{Ir}, the quadrature-phase carrier S_{Qr}, the in-phase component Iₜ, or the quadrature-phase component Qₜ. Under this ideal condition, there is no IQ imbalance.

However, when the phase difference between the in-phase carrier S_{Ir} and the quadrature-phase carrier S_{Qr} is not 90°, or when their amplitudes are different, the lower sideband signal will not be eliminated as shown in Equation (3) and Equation (4) to result in an image signal. As mentioned above, if the quadrature-phase carrier S_{Qr} is given an additional phase shift θ, the mixed signal can then be represented as:

$$- a \times sin ( 2 π {f}_{1} t ) sin ( 2 π {f}_{2} t + θ ) = \frac{- a}{2} cos ( ( 2 π {f}_{1} - 2 π {f}_{2} ) t - θ ) + \frac{a}{2} cos ( ( 2 π {f}_{1} + 2 π {f}_{2} ) t + θ ) \qquad Eq . ( 5 )$$

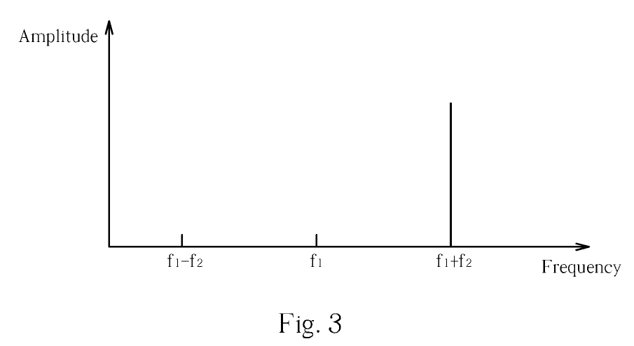

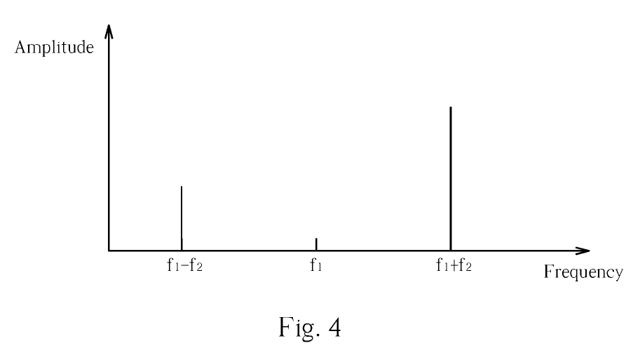

Therefore, in addition to the integrated upper sideband (f₁+f₂) signal in the transmitting signal Sₜ being shifted due to the additional phase shift θ, the integrated lower sideband (f₁−f₂) signal in the transmitting signal Sₜ is not eliminated, and the above-mentioned image signal results. Please refer to FIG. 3 and FIG. 4. FIG. 3 shows a diagram illustrating the relationship between the amplitude and frequency in an ideally mixed signal. FIG. 4 is a diagram illustrating the relationship between the amplitude and frequency in a mixed signal corresponding to a quadrature-phase carrier with an additional phase shift. As shown in FIG. 3, only the upper sideband (f₁+f₂) signal occurs in an ideally mixed signal. However, as shown in FIG. 4, an image signal occurs on the lower sideband (f₁−f₂) spectrum of the signal because of the additional phase shift.

Under non-ideal mixing as mentioned above, if the phase mismatch and the gain mismatch between these carriers are estimated correctly, distortion in demodulation caused by IQ imbalance can be compensated in a digital domain or in an analog domain. Since the calibration procedure for IQ imbalance is operated through the QAM transceiver 200 as shown in FIG. 2, the calibration unit 205 generates an input signal, where its in-phase component Iₜ is fed into the mixer 210 for up-conversion with the in-phase transmitting carrier S_{I}t. Similarly, the quadrature-phase component Qₜ of the input signal is fed into the mixer 220 for up-conversion with the quadrature-phase transmitting carrier S_{Qt}. The transmitting signal Sₜ is now transmitted to the loopback component 270 through the path selector 250. In this embodiment, the loopback component 270 provides an amplitude adjustment and a phase adjustment to adjust the transmitting signal Sₜ. This generates a loopback signal S_{lb}, which is then transmitted to the receiving end through the path selector 260. The output signal (i.e. the receiving signal Sᵣ) of the path selector 260 is then transmitted to the mixers 230 and 240, where the in-phase receiving carrier S_{Ir} and the quadrature-phase receiving carrier S_{Qr} are used for down-converting the receiving signal Sᵣ to generate the in-phase component Iᵣ and the quadrature-phase component Qᵣ, respectively, which correspond to the output signal. Finally, the output signal is fed into the calibration unit 205 for performing a calibration operation to estimate calibration parameters for IQ imbalance. Please note that the loopback component 270 provides a plurality of amplitude adjustments and phase adjustments in sets, and selects one set from these sets to adjust the amplitude and the phase of the transmitting signal Sₜ.

In this section a commonly used IQ imbalance model is used for illustrating the estimation of the calibration parameters in the present invention. We assume that the in-phase transmitting carrier S_{It}, the quadrature-phase transmitting carrier S_{Qt}, the in-phase receiving carrier S_{Ir}, and the quadrature-phase receiving carrier S_{Qr} are represented as follows:

S_{It}=(1+αₜ)cos(2πf₁t+θₜ) Eq. (6)

S_{Qt}=−sin(2πf₁t) Eq. (7)

S_{Ir}=(1+αᵣ)cos(2πf₁t+θᵣ) Eq. (8)

S_{Qr}=−sin(2πf₁t) Eq. (9)

In Equations (6), (7), (8), and (9), the values αₜ and αᵣ represent the amplitude error of the transmitting carrier and the amplitude error of the receiving carrier respectively, and the values θₜ and θᵣ represent the phase errors of the transmitting carrier and the phase error of the receiving carrier respectively. The frequency f₁ is a carrier frequency, while the value t is a time index.

As shown in Equations (6), (7), (8), and (9), there are four error parameters that must be estimated. In this embodiment, since the loopback component 270 provides two sets of amplitude adjustment A and phase adjustment θ_{d}, there are eight unknown values to be solved for the input signal and the output signal. For a specific input signal, the calibration loop of the QAM transceiver 200 is capable of providing four equations. Thus, if the calibration unit 205 is able to provide two sets of different input signals or more, at least eight equations are obtained to successfully solve these eight unknown values. We assume that the in-phase transmitting carrier Iₜ and the quadrature-phase transmitting carrier Qₜ are represented below as follows:

Iₜ=a×S Eq. (10)

Qₜ=b×S Eq. (11)

where a and b are scalars of the amplitude, and S is any base-band or middle-band signal. Therefore, the transmitting signal Sₜ can be represented as follows:

Sₜ=(1+αₜ)aS cos(2πf₁t+θₜ)−bS sin(2πf₁t) Eq. (12)

The loopback signal S_{lb} outputted by the transmitting signal Sₜ through the loopback component 270 is then shown in the following:

S_{lb}=A[(1+αₜ)aS cos(2πf₁t+θₜ−θ_{d})−bS sin(2πf₁t−θ_{d})] Eq. (13)

The loopback signal S_{lb} passes through mixers 230, 240, with the low-frequency component of the loopback signal S_{lb} being extracted with a low pass filter (LPF, not shown in FIG. 2). The in-phase component Iᵣ and the quadrature-phase component Qᵣ of the output signal can then be shown as follows:

Iᵣ=LPF{A[(1+αₜ)aS cos(2πf₁t+θₜ−θ_{d})−bS sin(2πf₁t−θ_{d})]×[(1+αᵣ)cos(2πf₁t+θᵣ)]}=(½)A(1+αₜ)(1+αᵣ)aS cos(θₜ−θ_{d}−θᵣ)+(½)A(1+αᵣ)bS sin(θ_{d}+θᵣ) Eq. (14)

Qᵣ=LPF{A[(1+αₜ)aS cos(2πf₁t+θₜ−θ_{d})−bS sin(2πf₁t−θ_{d})]×[−sin(2πf₁t)]}=(½)A(1+αₜ)aS sin(θₜ−θ_{d})+(½)AbS cos(θ_{d}) Eq. (15)

Assumptions are made for parameters αₜ, αᵣ, θₜ, and θᵣ<<1 to simplify Equations (14) and (15) as shown below:

Iᵣ=(½)AaS[(1+αₜ+αᵣ)cos θ_{d}+sin θ_{d}(θₜ−θᵣ)]+(½)AbS[(1+αᵣ)sin θ_{d}+cos(θ_{d}θᵣ)]Eq. (16)

Qᵣ=(½)AaS[−(1+αₜ)sin θ_{d} +cos(θ_{d}θₜ)]+(½)AbS cos(θ_{d}) Eq. (17)

Set values are substituted for (a, b) and (A, θ_{d}) respectively, with the resulting independent linear equations for each test set listed below:

(a, b)=(1, 0) and (A₁, θ_{d1})

2Iᵣ₁/S=A₁[(1+αₜ+αᵣ)cos θ_{d1}+sin θ_{d}](θₜ−θᵣ)] Eq. (18)

2Qᵣ₁/S=A₁[−(1+αₜ)sin θ_{d1}+cos(θ_{d1}θᵣ)] Eq. (19)

(a, b)=(0, 1) and (A₁, θ_{d1})

2Iᵣ₂/S=A₁[(1+αᵣ)sin θ_{d1}+cos(θ_{d1}θᵣ)] Eq. (20)

2Qᵣ₂/S=A₁ cos θ_{d1} Eq. (21)

(a, b)=(1, 0) and (A₂, θ_{d2})

2Iᵣ₃/S=A₂[(1+αₜ+αᵣ)cos θ_{d2}+sin θ_{d2}(θₜ−θᵣ)] Eq. (22)

2Qᵣ₃/S =A₂[−(1+αₜ)sin θ_{d2}+cos(θ_{d2}θᵣ)] Eq. (23)

(a, b)=(0, 1) and (A₂, θ_{d2})

2Iᵣ₄/S=A₂[(1+αᵣ)sin θ_{d2}+cos(θ_{d2}θᵣ)] Eq. (24)

2Qᵣ₄/S=A₂ cos θ_{d2} Eq. (25)

According to these above equations (18)-(25), all four error parameters including αₜ, αᵣ, θₜ, and θᵣ, are correctly calculated. These four error parameters can then be used to compensate for IQ imbalance using a prior art compensation scheme. This compensation scheme being well known to one skilled in the art is not discussed here for brevity. Please note that while the two sets of phase adjustments provided by the loopback component 270 are different, the above equations remain solved nonetheless. Moreover, when the difference between the two phase adjustments are 90°, the computation involved in solving these equations can be considerably simplified.

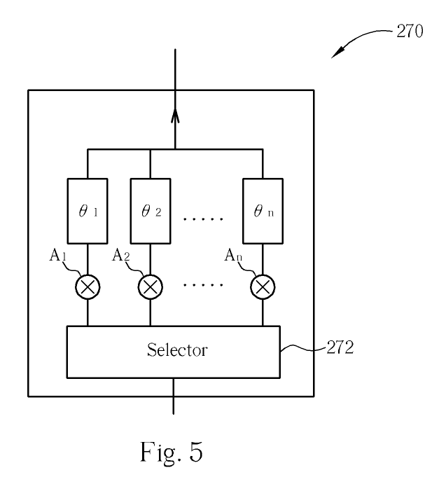

In practical applications, each set of amplitude and phase adjustments performed by the loopback component 270 corresponds to each individual path in the loopback component 270. That is, the amplitude adjustment and phase adjustment occurring for each path in the loopback component 270 varies. Therefore, different sets of amplitude and phase adjustments can be added into the transmitting signal Sₜ by selecting different paths. Please refer to FIG. 5. FIG. 5 is a diagram of an embodiment of the loopback component 270 shown in FIG. 2. As shown in FIG. 5, the loopback component 270 includes a plurality of paths and a selector 272, wherein the selector 272 is used to select one path from a plurality of paths. Each path corresponds to a specific amplitude adjustment A₁˜Aₙ and phase adjustments θ₁˜θₙ. In another embodiment of the loopback component 270, the selector 272 is placed in the output end of the loopback component 270. In this case, the transmitting signal Sₜ is fed into all paths, being adjusted by all the various amplitude adjustments A₁˜Aₙ and phase adjustments θ₁·θₙ, and a specific path is chosen through the selector 272 for passing a desired adjusted transmitting signal Sₜ to the receiving end of the path selector 260.

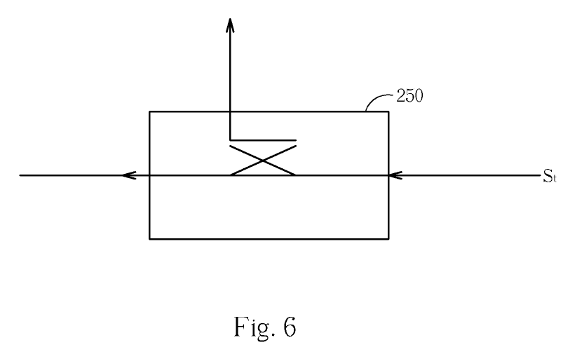

Please refer to FIG. 6. FIG. 6 is a diagram of an embodiment of the path selector 250 shown in FIG. 2. As shown in FIG. 6, the path selector 250 comprises a coupler implemented through two neighbor leads. When the transmitting signal Sₜ is fed into the path selector 250 a portion of energy is coupled and outputted to the coupling end. To ensure that the portion of coupled energy does not influence normal operation of the receiving end in the QAM transceiver 200, a switch (not shown) can be additionally set in the input end of the loopback component 270. The switch can be switched off while the QAM transceiver 200 performs normal operation, and turned on while the QAM transceiver 200 performs the calibration operation. Please note that the use of the switch largely depends on practical design requirements. Some implementations of QAM transceivers are such that the receiving end and the transmitting end do not operate simultaneously, where only one end operates at a time. In this situation, the switch is no longer necessary in the operation of the QAM transceiver 200. Please note that the use of the switch is just for an example and shall not be a limitation to the present invention. In another embodiment, the path selector 250 is implemented using a simple selector. The selector can couple the transmitting signal Sₜ to the antenna 280 while the QAM transceiver 200 undergoes the normal operation. The transmitting signal Sₜ can also be coupled to the loopback component 270 by the selector while the QAM transceiver 200 undergoes the calibration operation.

The QAM transceiver and the method for calibrating IQ imbalance disclosed in the present invention utilize a loopback component to provide two or more sets of amplitude and phase adjustments such that the outputted transmitting signal is accurately adjusted. The adjusted transmitting signal is then received and fed into the receiving end to estimate the error parameters for IQ imbalance. According to the present invention, additional circuits used in the present invention, i.e. the loopback component, reduce the occurrence of errors found in the prior art, and the cost function is thus not required for evaluating IQ imbalance, so stability will no longer be an issue to be considered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A quadrature modulation transceiver comprising:
a transmitter for receiving an in-phase component and a quadrature-phase component of an input signal, and for generating a transmitting signal by up-converting the in-phase component according to an in-phase transmitting carrier and the quadrature-phase component according to a quadrature-phase transmitting carrier;
a loopback component, coupled to the transmitter, for providing a loopback parameter to adjust the transmitting signal to generate a loopback signal, the loopback component comprising a plurality of sets of loopback parameters wherein the loopback parameter is a set selected from the plurality of sets of loopback parameters;
a receiver, coupled to the loopback component, for down-converting the loopback signal according to an in-phase receiving carrier and a quadrature-phase receiving carrier to generate an in-phase component and a quadrature-phase component of a receiving signal; and
a calibration unit, coupled to the transmitter and the receiver, for generating the input signal, receiving the receiving signal, and computing calibration parameter for IQ imbalance of the quadrature modulation transceiver.

2. The quadrature modulation transceiver of claim 1, wherein each set of the plurality sets of loopback parameters comprises at least an amplitude adjustment, a phase adjustment, or both.

3. The quadrature modulation transceiver of claim 1, wherein the calibration unit computes the calibration parameters for IQ imbalance of the quadrature modulation transceiver according to the receiving signal.

4. The quadrature modulation transceiver of claim 1, wherein the plurality of sets of loopback parameters respectively correspond to a plurality of paths in the loopback component.

5. The quadrature modulation transceiver of claim 4, wherein the loopback component further comprises:
a selector, coupled to the transmitter and the plurality of paths, for selecting a specific path in the plurality of paths according to the loopback parameter to transmit the transmitting signal.

6. The quadrature modulation transceiver of claim 4, wherein the loopback component comprises:
a selector, coupled to the receiver and the plurality of paths, for selecting a specific path in the plurality of paths according to the loopback parameter to transmit the loopback signal to the receiver.

7. The quadrature modulation transceiver of claim 1, further comprising:
a coupler, coupled to the transmitter and the loopback component, for coupling the transmitting signal to the loopback component.

8. The quadrature modulation transceiver of claim 7, wherein the loopback component further comprises:
a switch, coupled to the coupler, for determining whether an output of the coupler is being transmitted to the loopback component.

9. The quadrature modulation transceiver of claim 1, further comprising:
a selector, coupled to the transmitter and the loopback component, for determining whether the transmitting signal is being fed into the loopback component.

10. The quadrature modulation transceiver of claim 1, further comprising:
a coupler, coupled to the loopback component and the receiver, for coupling the loopback signal to the receiver.

11. The quadrature modulation transceiver of claim 10, wherein the loopback component further comprises:
a switch, coupled to the coupler, for determining whether an output of the coupler is being transmitted to the receiver.

12. The quadrature modulation transceiver of claim 1, further comprising:
a selector, coupled to the loopback component and the receiver, for determining whether the loopback signal is being fed into the receiver.

13. A method for estimating calibration parameters for IQ imbalance of a quadrature modulation transceiver, the method comprising:
receiving an in-phase component and a quadrature-phase component corresponding to an input signal;
up-converting the in-phase component according to an in-phase transmitting carrier and the quadrature-phase component according to a quadrature-phase transmitting carrier to generate a transmitting signal;
providing a loopback component to provide a loopback parameter to adjust the transmitting signal and produce a loopback signal, the loopback parameter being a set selected from a plurality of sets of loopback parameters;
down-converting the loopback signal to generate an in-phase component according to an in-phase receiving carrier and a quadrature-phase component according to a quadrature-phase receiving carrier; and
computing the calibration parameters for IQ imbalance of the quadrature modulation transceiver.

14. The method of claim 13, wherein each set of the plurality of sets of loopback parameters respectively correspond to a path in a plurality of paths, and each path corresponds to a specific set of loopback parameters for providing an amplitude adjustment and a phase adjustment.

15. The method of claim 14, wherein the step of providing the loopback parameter comprises:
selecting a specific path from the plurality of paths according to the loopback parameter to transmit the transmitting signal.

16. The method of claim 14, wherein the step of providing the loopback parameter comprises:
selecting a specific path from the plurality of paths according to the loopback parameter to transmit the loopback signal, the loopback signal subsequently down-converted according to the in-phase receiving carrier and the quadrature-phase receiving carrier.

17. The method of claim 13, wherein the calibration parameters are computed according to the receiving signal.

18. The method of claim 13, further comprising:
providing a coupler and utilizing the coupler to couple the transmitting signal to the loopback component.

19. The method of claim 18, further comprising:
providing a switch and utilizing the switch to determine whether an output of the coupler is being transmitted to the loopback component.

20. The method of claim 13, further comprising:
providing a selector and utilizing the selector to determine whether the transmitting signal is being fed into the loopback component.

21. The method of claim 13, further comprising:
providing a coupler and utilizing the coupler to couple the loopback signal for down-conversion according to the in-phase receiving carrier and the quadrature-phase receiving carrier.

22. The method of claim 21, wherein the loopback component comprises:
a switch for determining if an output of the coupler is transmitted to the in-phase receiving carrier and the quadrature-phase receiving carrier.

23. The method of claim 13, further comprising:
providing a selector and utilizing the selector to determine whether the loopback signal is being fed to the in-phase receiving carrier and the quadrature-phase receiving carrier.
